(19) United States
(12) Patent Application Publication
(10) Pub. No.: US 2012/0202180 A1
(43) Pub. Date: Aug. 9, 2012

(54) Training Device For Medical Procedures

(75) Inventors: Lawrence Stock, Malibu, CA (US); Royce Rumsey, Laguna Beach, CA (US)

(73) Assignee: PYNG MEDICAL CORP., Richmond, BC (CA)

(21) Appl. No.: 13/124,222

(22) PCT Filed: Oct. 14, 2009
(86) PCT No.: PCT/CA09/01467

§ 371 Date: Apr. 24, 2012

Related U.S. Application Data
(60) Provisional application No. 61/105,418, filed on Oct. 14, 2008.

(51) Int. Cl. G09B 23/28

(52) U.S. Cl. 434/272

(57) ABSTRACT

A training device includes a tracheal module for simulating a trachea of a mammal, the tracheal module being flexible and including a pair of severable membranes for receiving an incision to simulate a medical procedure and being selectively receivable in a base unit.

### FIELD OF THE INVENTION

This invention relates to medical training devices. More specifically, this invention relates to devices configured for training the performance of emergency medical procedures.

### BACKGROUND OF THE INVENTION

In certain emergency situations involving serious traumatizing injuries, first responders must immediately perform medical procedures to re-establish and stabilize the individuals' key physiological functions. Such procedures are exemplified by tracheotomies, tracheostomies, cricothyrotomies, installation of nasopharayngeal airways, installation and administration of solutions such as blood, plasma and saline via intraosseous and/or intravenous routes. Such procedures are typically invasive into the injured individual's throat and/or chest and/or vascular systems in their upper torsos and/or appendages, and must be administered in less than ideal weather and lighting conditions. For example, tracheotomies, tracheostomies, cricothyrotomies may have to be performed as soon as possible in emergency situations when the air passages leading to an individual's trachea from the mouth and/or nose are obstructed or seriously damaged and an alternative airway is essential to maintain breathing for the supply of oxygen to their lungs.

Tracheotomies and tracheostomies are surgical procedures performed on a subject's throat to open a direct airway to enable respiration to continue, by making an incision into the trachea followed by installation of specially designed tubes commonly known as tracheostomy tubes. Cricothyrotomies are performed in emergency situations to rapidly incise an opening through the skin and cricothryod membrane overlying the trachea in order to establish means for maintaining respiration in emergency situations where the subject's airway is blocked by foreign objects or by swelling, or as a consequence of major facial trauma and damage to the nasal and oral passages leading into the trachea.

Tracheotomy, tracheostomy and cricothyrotomy procedures are typically performed by skilled medical personnel including paramedics, emergency physicians, and surgeons. Related surgical procedures involving dissection with scalpels typically result in blood release and are difficult for first responders to administer in emergency field situations with poor weather and/or lighting conditions. Cricothyrotomies are considered easier and faster than tracheotomies and tracheostomies, but because of the need for precision during the incision of an opening into trachea via the cricothryroid membrane just underneath the thyroid cartilage, these procedures are using performed as last resorts under emergency situations. Various types of percutaneous cricothyrotomy devices and techniques have been developed for such applications and are now widely used. The problem with all of these devices and techniques is that in stressful emergency situations combined with, in certain cases, poor lighting and weather conditions, first-responders often experience confusion and lack of confidence for the manipulation of percutaneous cricothyrotomy devices to achieve rapid, precise and successful installation of tracheostomy tubes in life-threatening situations, because of problems with visualizing target incision sites and unfamiliarity with the subject's physical landmarks associated with their thyroid-cricoid-tracheal cartilage system.

### BRIEF DESCRIPTION OF THE DRAWINGS

The present invention will be described in conjunction with reference to the following drawings, in which:

FIG. 1 is a cross-sectional view of an exemplary installation of a tracheotomy tube after a cricothyrometry procedure;

FIG. 2 is perspective view showing an exemplary embodiment of the training device of the present invention comprising the base module and the trachea module;

FIG. 3(a) is a side view perspective view showing the trachea module from FIG. 2, while 3(b) shows an alternative embodiment of the trachea module;

FIG. 4 is a cross-sectional side view showing the trachea module from FIG. 3(a);

FIG. 5 is a top view showing the separated components comprising the trachea module from FIG. 3(b);

FIG. 6 is a perspective view showing the trachea module from FIG. 2 inserted into the based module from FIG. 2;

FIG. 7 is a perspective view of an exemplary kit of the present invention comprising the modular training device from FIG. 2, an exemplary percutaneous cricothyrotomy device, and an exemplary tracheotomy tube;

FIG. 8 is a close-up side view showing the surgical blade of an exemplary percutaneous cricothyrotomy device being inserted into the trachea module from FIG. 2;

FIG. 9 is a perspective view showing a trainee gripping the trachea module which is cooperating with the base module, and manipulating the percutaneous cricothyrotomy device to make an incision through the simulated skin surface area of the trachea module;

FIG. 10 is a perspective view showing the trainee manipulating the percutaneous cricothyrotomy device such that its jaws are spreading apart the incision made through the simulated skin component of the trachea module;

FIG. 11 is a perspective view showing trainee inserting the tracheotomy tube through the incision while manipulating the percutaneous cricothyrotomy device so that its jaws maintain the incision open;

FIG. 12 is a perspective view showing the tracheal tube inserted in the trachea component at the completion of the training session;

FIG. 13 is a perspective view showing the tracheal tube component engaged with the tracheal cartilage component, and the engaged components being manipulated to demonstrate their flexibility and resilience;

FIG. 14 is a perspective view showing an exemplary tracheotomy tube inserted through adjacent tracheal cartilage components into a trachea;

FIG. 15 is a perspective top view of an exemplary tracheal cartilage component according to one aspect of the present invention; and

FIG. 16(a) is a cross-sectional side view of the base component in a “relaxed” state according to one aspect of the invention, 16(b) is a cross-sectional side view showing the base component in a “hyper-extended” state.

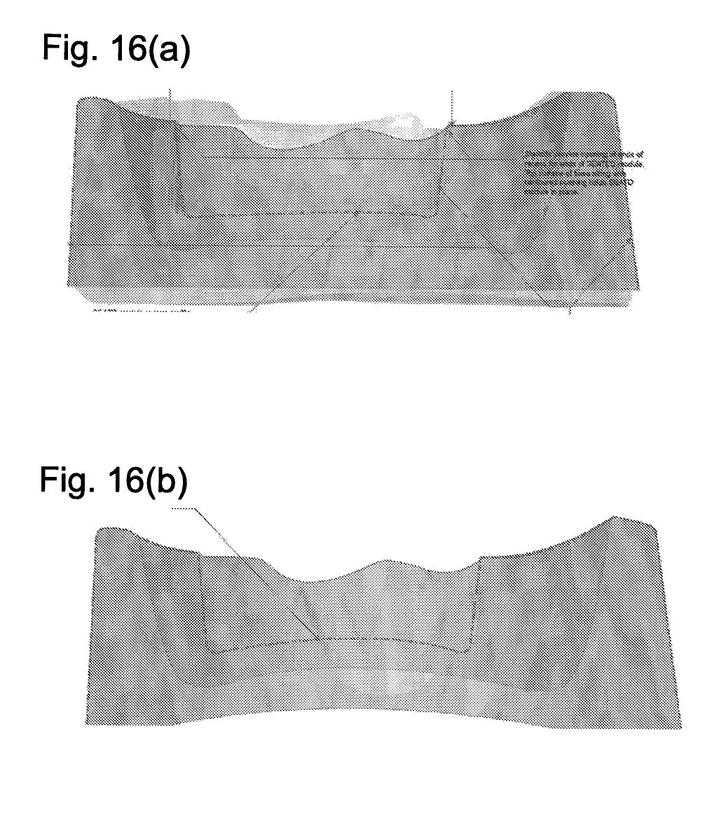

### DETAILED DESCRIPTION OF THE INVENTION

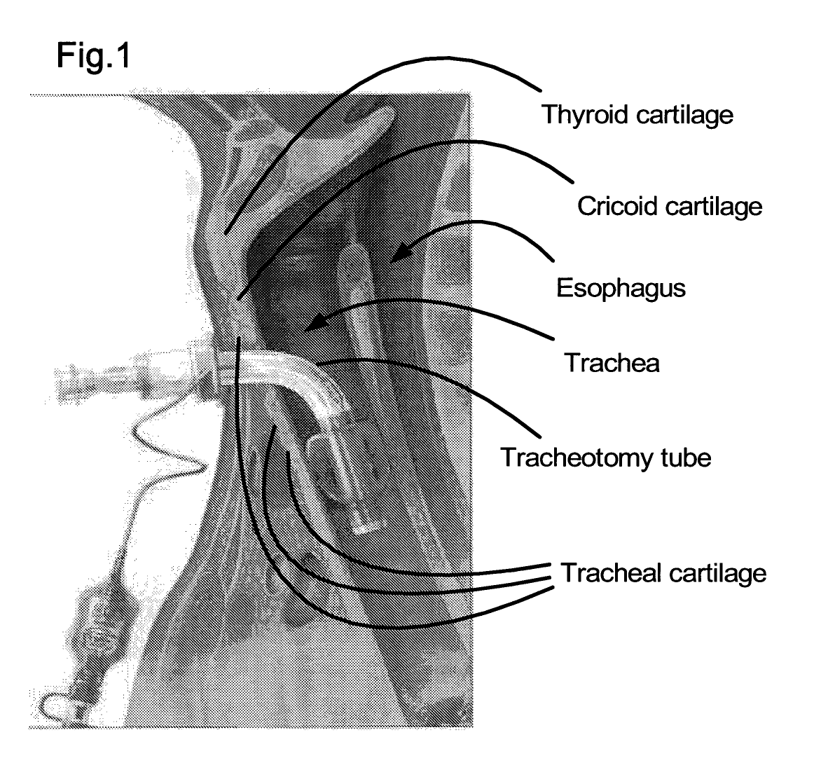

Exemplary embodiments of the present invention relate to training devices configured for performance of emergency medical procedures that provide accurate tactile sensory representation of the performance of the procedures in real-life situations, and to kits comprising the training devices. Exemplary emergency medical procedures that can be performed with these devices include tracheotomies, tracheostomies and cricothyrotomies. FIG. 1 is a cross-sectional schematic diagram showing the installation of a tracheotomy tube into a trachea in between the upper tracheal cartilages. Ideally, a first responder should make an incision through the skin and epidermal layers, in through the opening between the thyroid cartilage and the cricoid cartilage, spread the incised opening sufficiently wide to insert the tracheotomy tube into the trachea, and secure the tube to the throat surface of the subject.

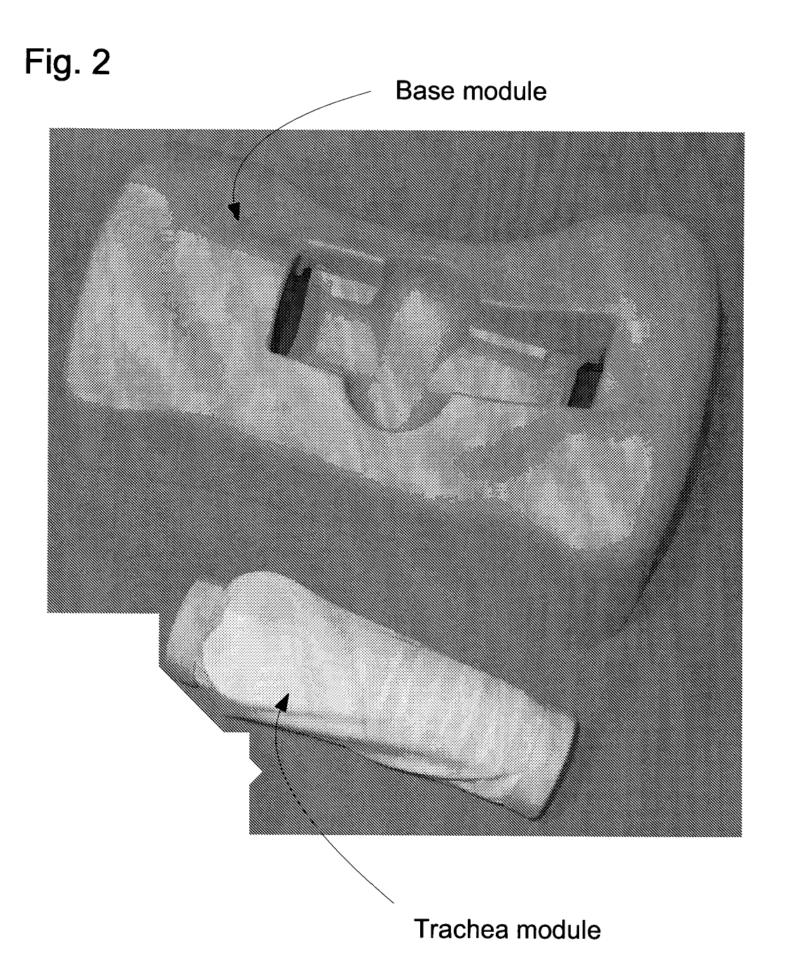

An exemplary embodiment of a training device according to the present invention is configured for enabling an individual to practice performing emergency medical procedures related to rapid installation of tracheal air tubes, i.e., tracheal intubations, through a subject's throat into their trachea. An illustrative exemplary device is shown in FIGS. 2 and 6-11 and generally comprises at least two components. The first component is a base unit and is provided with a generally flat bottom surface that can be placed onto a work surface on which the practice of the medical procedure can be safely performed. The dimensions of the base unit generally approximate the neck and throat area of an adult human. The upper surface area of the base unit is provided with a receptacle configured to receive and releasibly engage a second module, i.e., the training module. The opposing sides along the longitudinal axis of the receptacle are each provided with a vertically oriented recess configured to accommodate insertion of a finger thereby enabling the insertion and adjustment of the training module during preparation of the device for a training session, and for post-training removal of the training module from the base unit. The finger recesses are positioned in the base unit such that a trainee is enabled to properly position their fingers for manipulation of the tracheal area during performance of the emergency tracheal intubation procedure. The base unit is molded with a suitable pliant resilient material selected for its squeezability and manipulability during performance of the emergency tracheal intubation procedure to enable the trainee to manipulate the training module about the base unit, and also to hyper extend the base unit upward, in a manner that approximates the tactile properties of a human subject during the in vivo performance of such procedures.

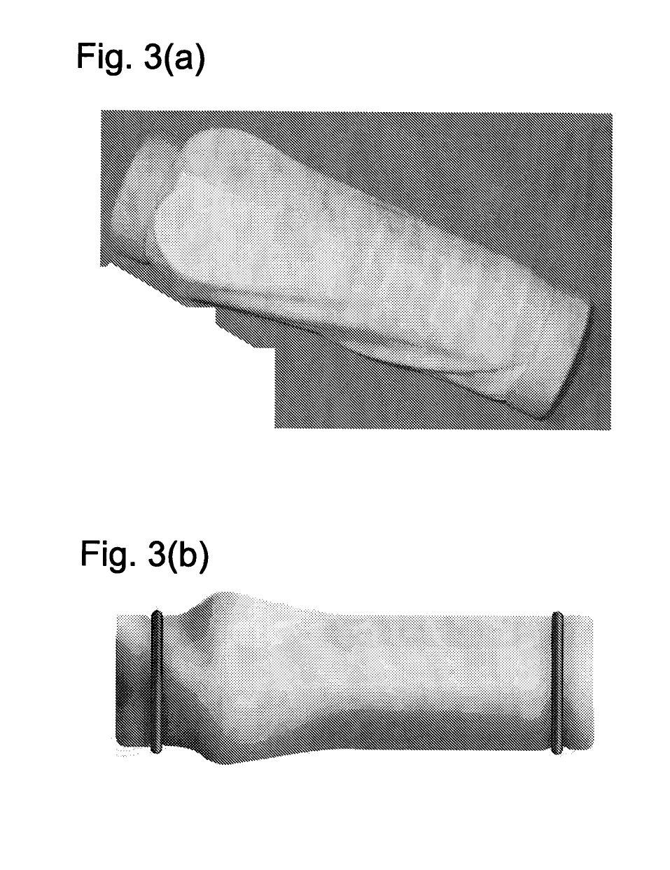

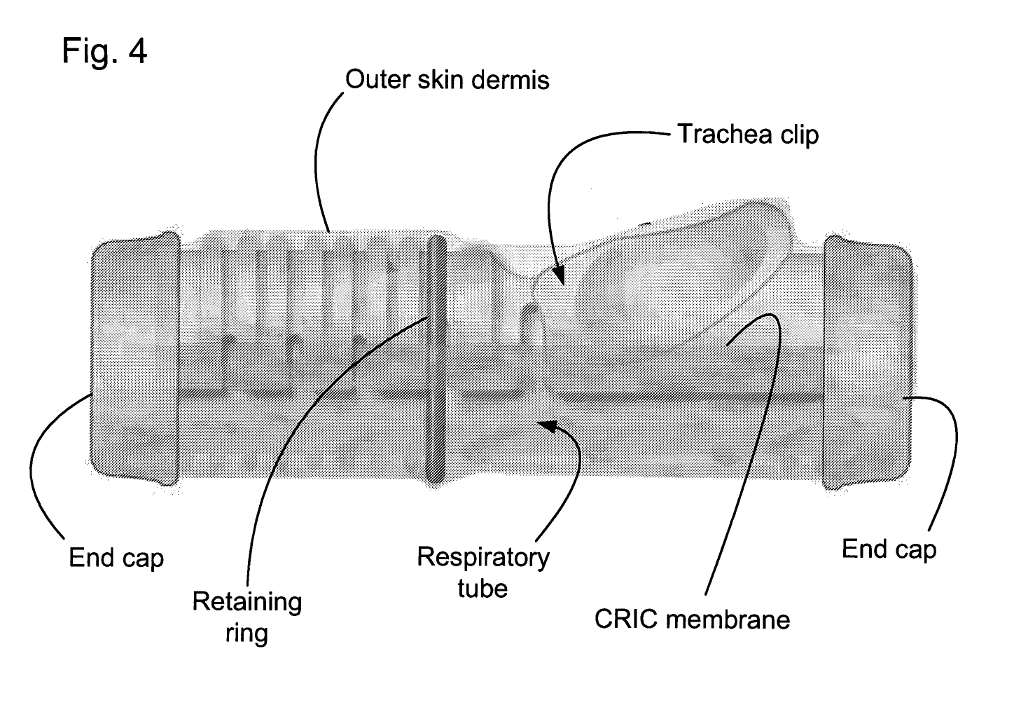

An exemplary embodiment of the present invention relating to the training module of the training device is shown in FIGS. 3(a) and 4. and genereally comprises at four main components and several fittings provided to secure the components after assembly, and to enable rapid dis-assembly and re-assembly. Referring to FIGS. 3(a) and 3(b), the first component is a respiratory tube comprising a flexible and resilient material, and is formed with a series of outward facing rings encompassing the tube in a pattern that approximates the physical structure of a human trachea. At least one tracheal opening aligned laterally along the length of the tube with at least one cricothyroid opening are molded along one side of the tube. The second component comprises a pliable resilient membraine material which can be fused into a cylinder, or alternatively produced as a cylinder. A suitable material for the second component is exemplified by 2 mm-3 mm Mylar film or vinyl firm, and other like films familiar to those skilled in these arts. The second component is sized to fit over the respiratory tube somewhat snugly. The portions of the second component that overlay the tracheal opening and the cricothyroid opening are the target areas for performance of the emergency tracheal intubation procedure. The third component is a “clip” (subsequently referred to herein as a “tracheal clip”) formed as an elongate half-round trough with the following sequentially molded portions: a gromment-retaining groove, a thyroid cartilage, a cricoid surface portions extending into a raised half-ring portion representing the cricoid cartilage followed by a series of similarly molded raised half-ring ribs representing sequential tracheal cartilages. The spaces between the thyroid cartilage, the cricoid cartilage and the first tracheal cartilage are provided with bores that are alignable with the openings molded into the respiratory tube. It is optional to provide additional bores between adjacent cartilage ribs. The tracheal clip can be produced by injection molding or alternatively, cast molding using pliable resilient materials that will enable a trainee to manipulate the clip with a tactile sensation of a human trachea. The fourth component is configured to provide a surface texture resembling the skin and epidermal layers overlying the tracheal cartilages and trachea, and generally comprises a pliable resilient membraine material which can be fused into a cylinder, or alternatively produced as a cylinder. A suitable material for the fourth component is exemplified by 3 mm-3 mm Mylar film or vinyl firm, and other like films familiar to those skilled in these arts. The fourth component is sized to fit over the tracheal clip somewhat snugly. The materials comprising the second and fourth components are preferably selected for their surface and structural properties that are configured to provide a tactile response that is comparable to the human body surface ant the underlying epidermal and endodermal layers. Suitable materials are exemplified by latex compositions, polythelene compositions, polypropyline compositions, and materials comprising multiple layers of one or more such compositions and the like.

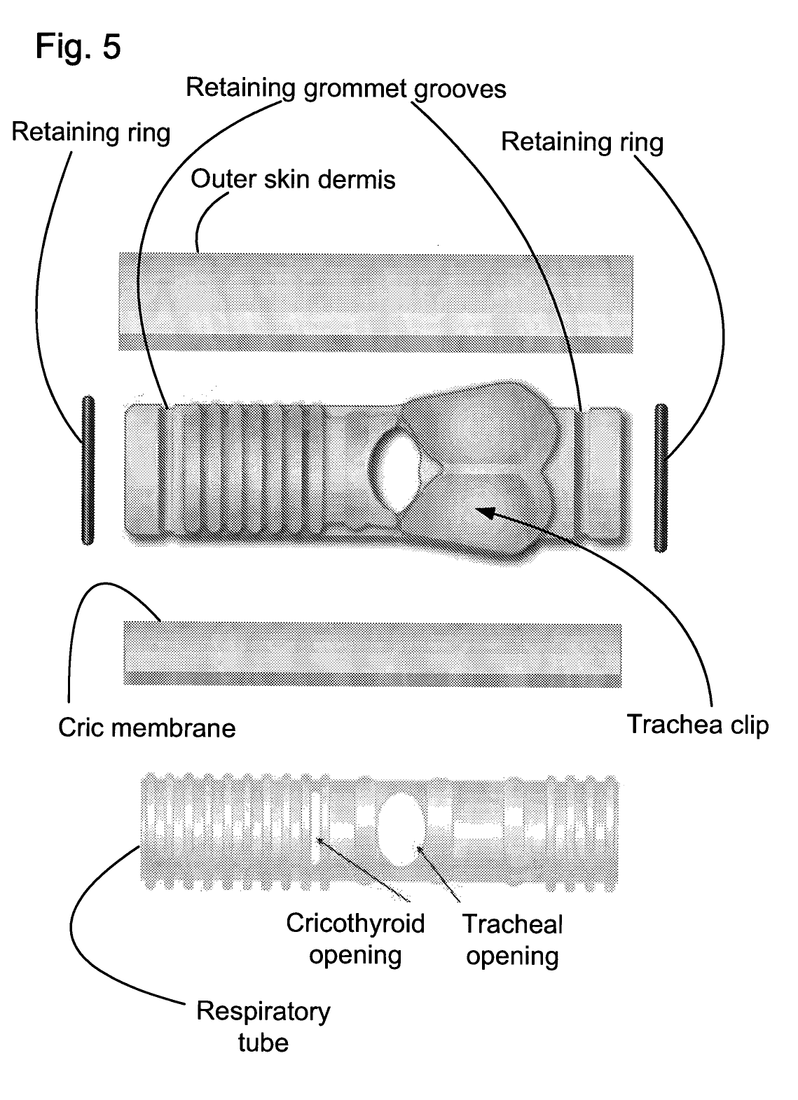

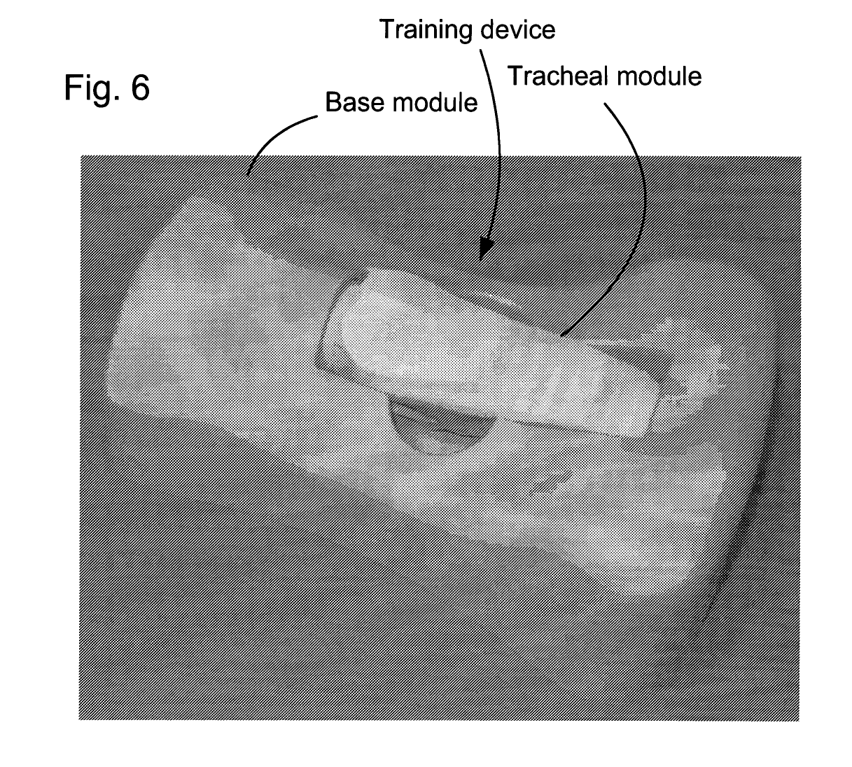

These exemplary training modules (i.e., the tracheal module) are assembled by inserting the first component, i.e., the respiratory tube into the second component, then overlaying the tracheal clip onto the assembled first and second components such the tracheal and cric openings in the tracheal clip and respiratory tube are aligned. A rubber ring is then slipped over the three aligned components to secure them together. Finally, the fourth component is slipped over the three assembled components and its ends are secured in place with end caps (FIG. 4) or rubber rings (FIG. 5). FIG. 6 shows the training module inserted into the base module of the training device of the present invention, and illustrates the anatomical reference for a trainee receiving instruction on the execution of an emergency tracheal intubation procedure.

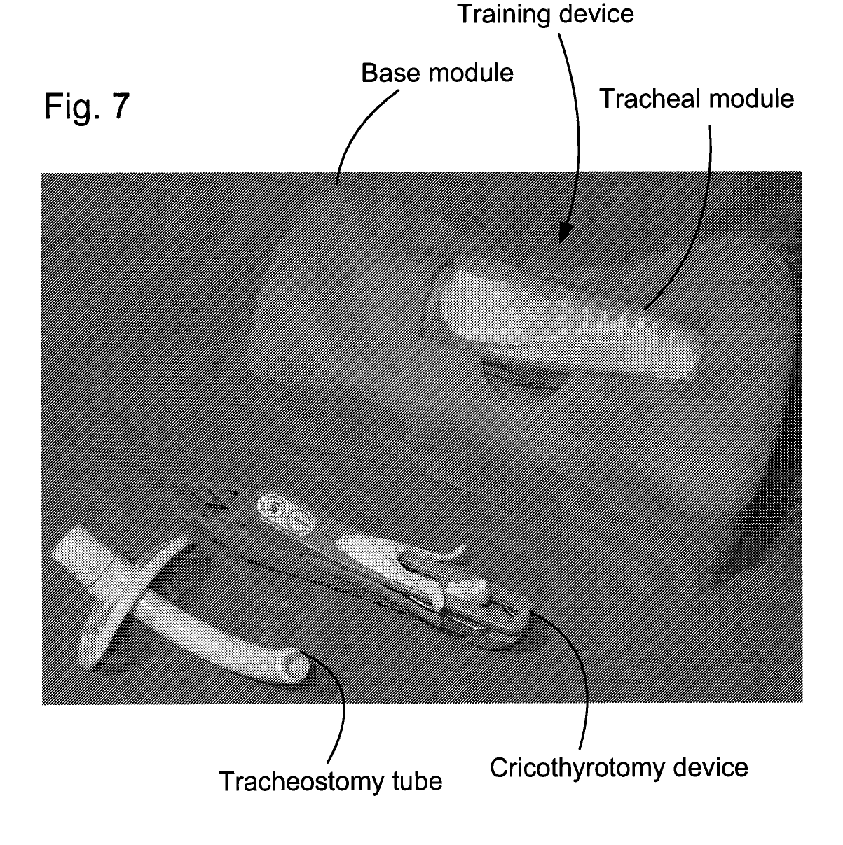

An exemplary kit according to another embodiment of the present invention is shown in FIG. 7 and generally comprises a training device of the present invention, a percutaneous cricothyrotomy device and at least one tracheotomy tube or other similarly fashioned tubing. Other optional kits may comprise a plurality of the second component, or alternatively, a plurality of the fourth component, and further alternatively, combinations of pluralities of the second and fourth components. Other optional kits may comprise pluralities of one or both of the second and fourth components in combination with a plurality of tracheotomy tubes or suitable facsimiles of the tubes. It is within the scope of the present invention to provide suitable packaging for containing the kits. It is also within the scope of the present invention to provide instructions for the use of the kits for instruction of trainees on the performance and/or execution of tracheal intubations, cricothyrotomies and similar types of emergency medical procedures.

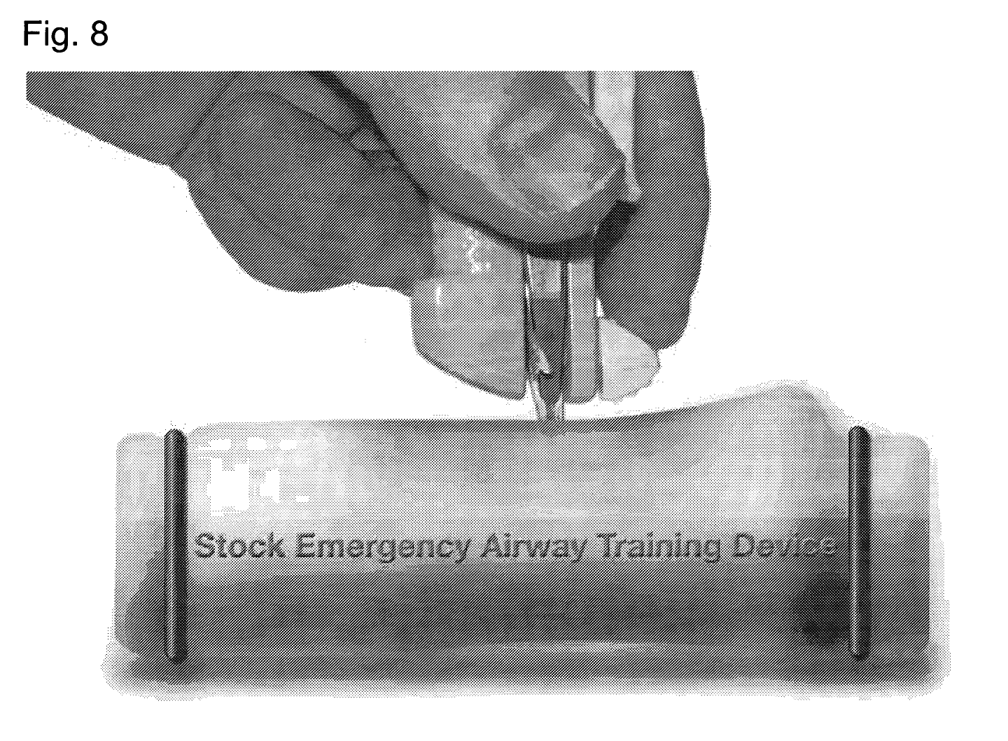

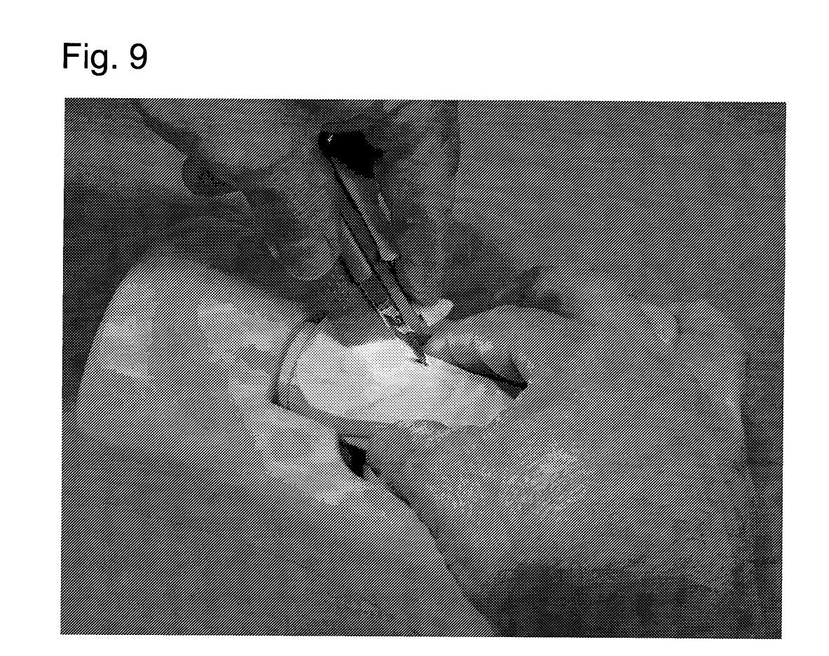

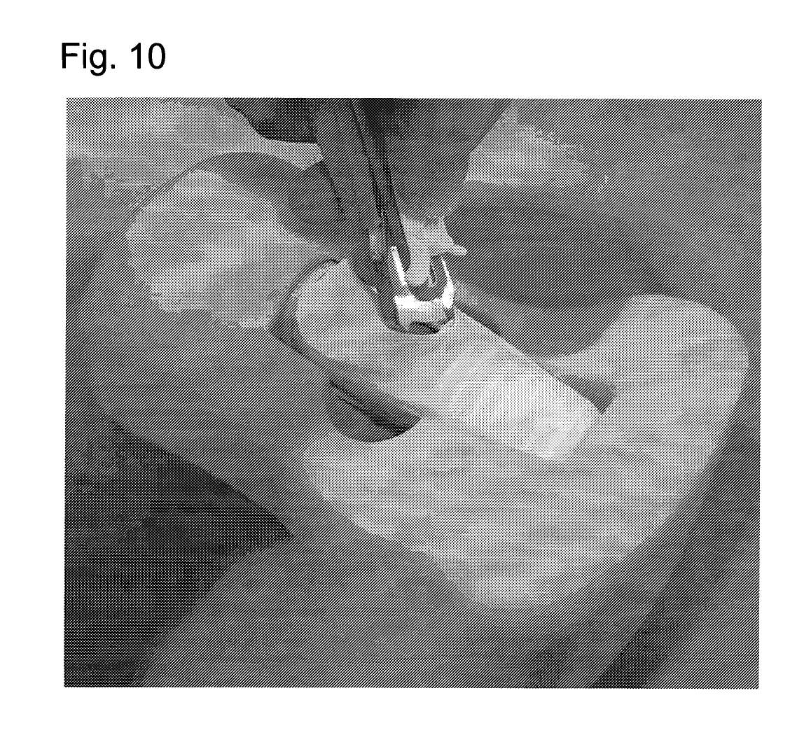

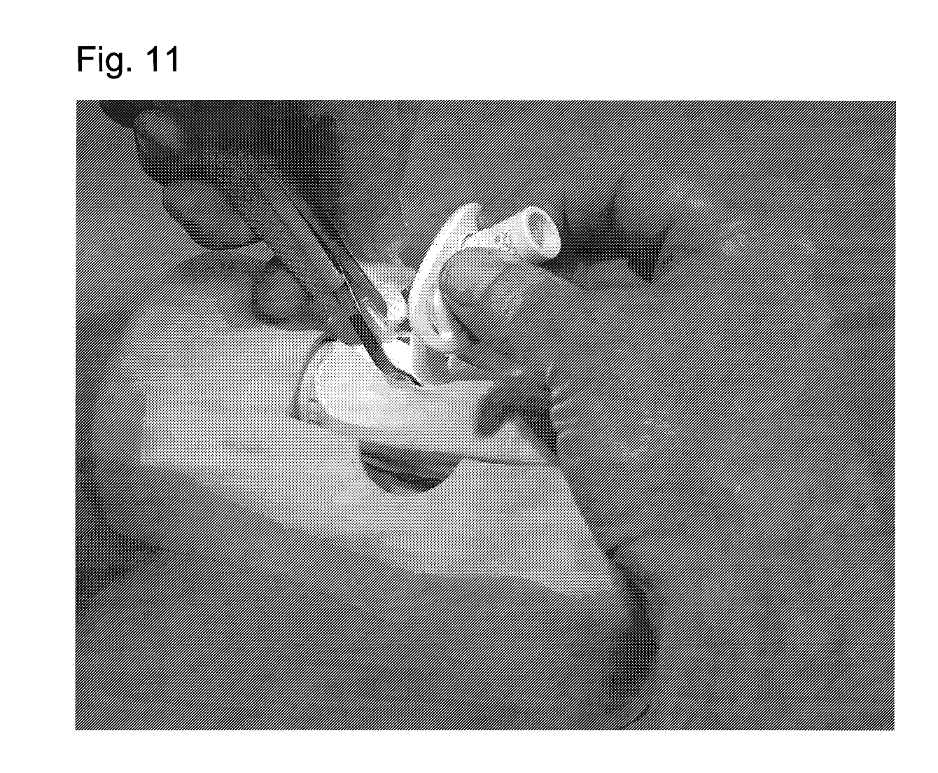

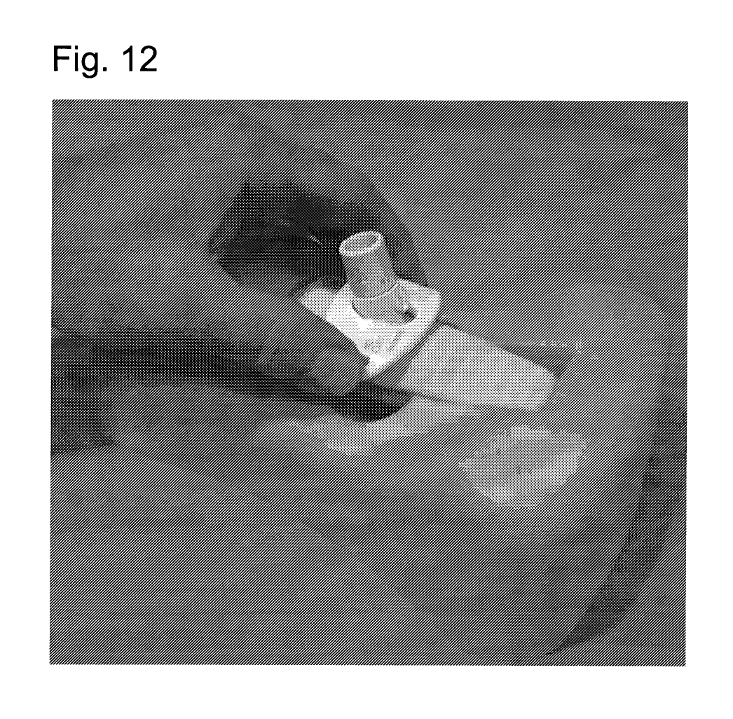

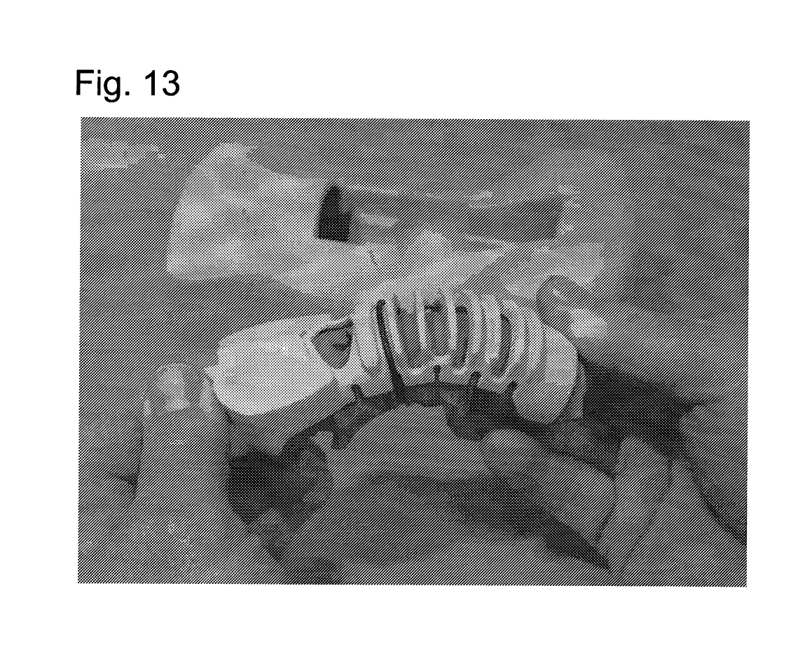

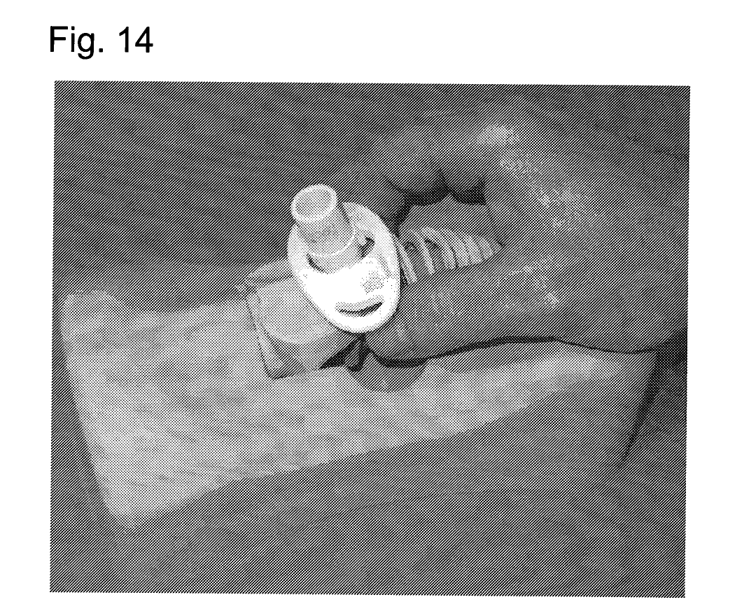

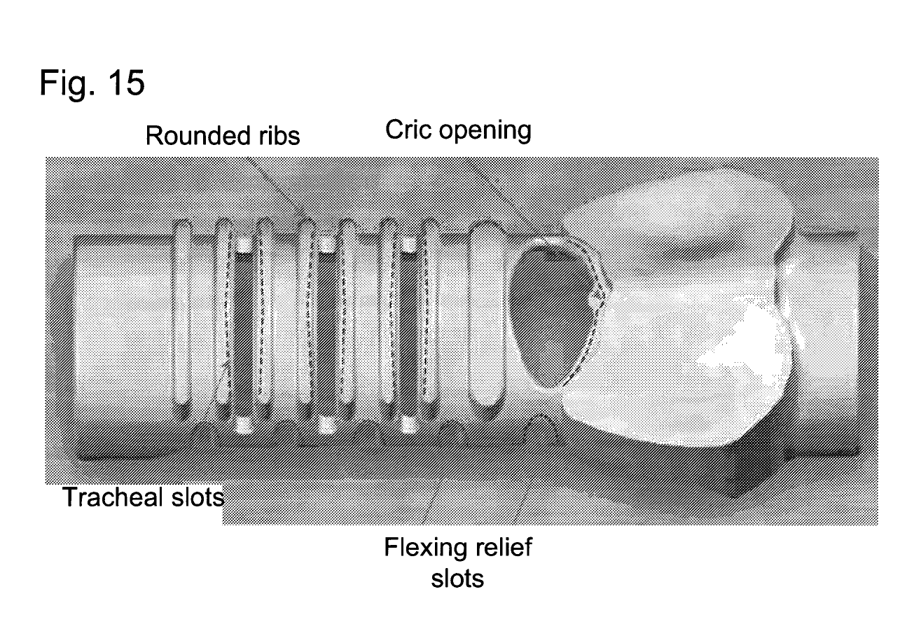

The uses of the training devices and/or kits of the present invention are shown in FIGS. 8-14. FIG. 8 is a close-up view of a percutaneous cricothyrotomy device being used to create an incision into the tracheal openings of a tracheal clip and respiratory tube comprising an training tracheal module of the present invention. FIGS. 9-11 show a series of steps in the training execution of a cricothyrotomy wherein trainer using an illuminating percutaneous cricothyrotomy device (CRIC™ Cricothyrotomy System, Pyng Medical Corp., Richmond, BC, Canada) is shown making an incision through the fourth component of the tracheal module in FIG. 9, while FIG. 10 shows the CRIC™ spreaders extending through the four components and opening the incision made into the fourth and second components, while FIG. 11 shows the trainer installing the tracheotomy tube into the opened incision being so maintained the CRIC™ spreaders. FIG. 12 shows the tracheotomy tube in an installed position. FIGS. 13 and 14 show the first and third components, i.e., the tracheal clip and the respiratory tube, overlaid and cooperating to illustrate the pliability, resilience and manipulability aspects that provide the tactile representation of a human throat and the underlying tracheal system, and the manipulability of the tracheal module within the base unit (FIG. 14). FIG. 15 shows options for adjusting and tailoring the topographical architecture and structure of the tracheal clip. The componentized and modular design of the training devices of the present invention facilitate the ease of assembly, dis-assembly and re-assembly of the tracheal module to remove and replace the second and fourth components to enable extensive and long-term re-use of the training devices, thereby enabling multiple practice performances of emergency tracheal intubations using percutaneous cricothyrotomy devices to develop and enhance the skills and confidence of front-line personnel in their delivery of these types of emergency procedures in less than ideal medical care situations and environments.

It is to be noted that while the present disclosure refers to and illustrates a training device configured to provide a tactile representation of the throat and underlying tracheal system of an adult human, it is within the scope of the present invention to adjust the size of the base unit and the tracheal module to provide simulations of the throat areas of infant through adolescents through juvenile through adult humans. It is also within the scope of the present invention, for veterinary training purposes, to configure the base unit and the tracheal module to represent mammalian animal species such as canines, felines, equines, livestock, exotic animals and other species for which veterinary emergency tracheal intubation procedures are required.

While this invention has been described with respect to the exemplary embodiments, it is to be understood that various alterations and modifications can be made to the exemplary embodiments disclosed herein, which are limited only by the scope of the appended claims.

1. A training device comprising:
a tracheal module for simulating a trachea of a mammal, said tracheal module being flexible and comprising a pair of severable membranes for receiving an incision to simulate a medical procedure.

2. A training device as claimed in claim 1, wherein said tracheal module comprises:
a flexible cover having a channel, a first opening and a second opening;
a flexible tube having a first opening and a second opening, said tube being received in said channel of said cover with first openings of said cover and said tube being aligned to simulate a cricothyroid opening and second openings of said cover and said tube being aligned to simulate a tracheal opening;
a first membrane covering said first opening and said second opening of said cover;
a second membrane covering said first opening and said second opening of said tube, said first membrane and said second membrane being severable to provide an air passage through said first openings; and
wherein an incision through said first membrane and said second membrane simulates a medical procedure.

3. A training device as claimed in claim 1, wherein said medical procedure is one of: a tracheotomy and a cricothyrotomy.

4. A training device as claimed in claim 2, comprising a base unit for receiving said tracheal module.

5. A training device as claimed in claim 4, wherein said base unit includes a lower surface for engaging a work surface and a cavity for receiving said tracheal module.

6. A training device as claimed in claim 5, wherein said base unit is made of a resilient material, said base unit for allowing user-engagement of the tracheal module during performance of said medical procedure.

7. A training device as claimed in claim 4, wherein said base unit is used with a plurality of tracheal modules.

8. A training device as claimed in claim 2, wherein said first membrane and said second membrane are removed following said medical procedure and replaced with intact membranes to allow for re-use of said training device.

9. A training device as claimed in claim 2, wherein side edges of said flexible cover include flexing relief slots.

10. A method for training an individual to perform a medical procedure, said method comprising:
providing a tracheal module, said tracheal module comprising a pair of severable membranes for receiving an incision to simulate a medical procedure;
providing instructions for performing said medical procedure;
wherein said tracheal module is flexible to simulate a trachea of a mammal.

11. A method as claimed in claim 10, wherein said medical procedure is one of: a tracheotomy and a cricothyrotomy.

12. A method as claimed in claim 10, comprising providing another tracheal module for performing a second simulated medical procedure.

13. A method for training an individual to perform a medical procedure, said method comprising:
providing a tracheal module that anatomically, in geometric, textural, and dynamic aspects, replicates a human trachea, said tracheal module comprising:
a geometrically and dynamically accurate replication of the human airway passage;
a geometrically, texturally and dynamically accurate replication of a human cricythyroid membrane;
a geometrically, texturally and dynamically accurate replication of the human tracheal cartilage;
a geometrically, texturally and dynamically accurate replication of the human skin in the tracheal area, said human skin and cricythyroid membrane simulated components being capable of receiving incision and spreading of an incised area to simulate said medical procedure; and
providing instructions for performing said medical procedure.

14. A method as claimed in claim 13, wherein said tracheal module is selectively received in a base unit, said base unit geometrically replicates the human anatomy relevant to said medical procedure.

15. A method as claimed in claim 14, wherein said assembly of said tracheal module and said base unit provides for meaningful replication of the human anatomy and education and training as to locating landmarks for said medical procedure.
